(19) United States
(12) Patent Application Publication
(10) Pub. No.: US 2025/0292431 A1
(43) Pub. Date: Sep. 18, 2025

(54) THREE-DIMENSIONAL MULTI-CAMERA PERCEPTION SYSTEMS AND APPLICATIONS

(71) Applicant: NVIDIA Corporation, Santa Clara, CA (US)

(72) Inventors: Zheng Tang, Bothell, WA (US); Yizhou Wang, Milpitas, CA (US); Ibrahim Orcun Cetintas, Munich (DE); Sameer Satish Pusegaonkar, San Francisco, CA (US); Ganapathy Seshadri Cadungude Aiyer, San Jose, CA (US); Shuo Wang, San Jose, CA (US); Akshay Agrawal, Santa Clara, CA (US); Sujit Biswas, Newark, CA (US); Tim Meinhardt, Munich (DE); Laura Leal Taixe, Florence (IT)

(21) Appl. No.: 18/898,120

(22) Filed: Sep. 26, 2024

Related U.S. Application Data
(60) Provisional application No. 63/566,549, filed on Mar. 18, 2024.

(30) Foreign Application Priority Data
Sep. 9, 2024 (IT) 102024000020065

(51) Int. Cl. G06T 7/73; G06T 7/80

(52) U.S. Cl. CPC G06T 7/74; G06T 7/85; G06T 2200/04; G06T 2207/30196; G06T 2207/30208

(57) ABSTRACT

In various examples, three-dimensional multi-camera perception systems and applications is described herein. Systems and methods are disclosed herein that process image data generated using multiple cameras located throughout an environment in order to directly determine three-dimensional (3D) information associated with objects located within the environment. For instance, the image data may be processed using one or more feature extractors (e.g., one or more backbones) to determine multi-view image features associated with images represented by the image data. These multi-view image features, along with calibration data associated with the cameras, may then be processed using one or more spatio-temporal transformers (e.g., one or more spatial encoders, one or more temporal encoders, etc.) in order to determine 3D locations of objects within the environment.

### CROSS-REFERENCE TO RELATED APPLICATIONS

This application claims the benefit of U.S. Provisional Application No. 63/566,549, filed Mar. 18, 2024, and Italian Patent Application No. 102024000020065, filed Sep. 9, 2024. Each of which is incorporated herein by reference in its entirety.

### BACKGROUND

Determining three-dimensional (3D) locations of objects within certain environments is important for many tasks, such as to track the objects within retail and/or warehouse environments. Conventional systems that determine 3D locations within an environment may receive image data generated using multiple cameras located throughout an environment, where each camera includes a respective field-of-view that captures a portion of the environment. The conventional systems may then individually process the images data from the respective cameras in order to determine two-dimensional (2D) locations of the objects within images represented by the image data. Next, to determine the 3D locations, the conventional systems may use calibration information associated with the cameras to project the 2D locations of the objects from the images to a 3D coordinate space associated with the environment.

However, many problems may occur when projecting the 2D locations to the 3D coordinate space associated with the environment. For instance, the projection of the 2D locations may be compromised by various factors, such as occlusions within the images (e.g., objects being obstructed by other objects), inaccurate calibration of the cameras, and/or a misalignment in object detections across cameras that include overlapping fields-of-view. Because of this, the accuracies of these conventional systems for determining 3D locations of objects may be reduced, which may further cause problems with downstream tasks such as tracking the objects within the environments using the 3D locations. Additionally, these problems with the conventional systems may be more prevalent in certain environments, such as complex environments (e.g., retail environments, warehouse environments, etc.) that include large numbers of cameras located throughout the environments and/or large amounts of space that is occluded from one or more of the cameras.

### SUMMARY

Embodiments of the present disclosure relate to three-dimensional multi-camera perception systems and applications. Systems and methods are disclosed herein that process image data generated using multiple cameras located throughout an environment in order to directly determine three-dimensional (3D) information associated with objects located within the environment. For instance, the image data may be processed using one or more feature extractors (e.g., one or more backbones) to determine multi-view image features associated with the image data. These multi-view image features, along with calibration data associated with the cameras, may then be processed using one or more spatio-temporal transformers in order to determine 3D locations of objects within the environment. For instance, and as described in more detail herein, a spatial encoder may process the multi-view image features along with the calibration data to generate bird's-eye-view (BEV) features. A temporal encoder may then fuse the current BEV features with instances of previous BEV features associated with previous time periods. A decoder may then process these fused BEV features in order to determine the 3D locations of the objects.

In contrast to conventional systems, such as those described above, the system of the present disclosure may directly determine the 3D locations associated with the objects without needing to initially determine 2D locations corresponding to different images and/or projecting 2D locations from image space to a 3D coordinate space associated with an environment. As such, the systems of the present disclosure may eliminate projection errors that may arise from occlusions within the images (e.g., objects being obstructed by other objects), inaccurate calibration of the cameras, and/or a misalignment in object detections across cameras that include overlapping fields-of-view. By eliminating these projection errors, the systems of the present disclosure may improve the overall accuracy of determining the 3D locations, especially in complex environments (e.g., retail environments, warehouse environments, etc.) that include large numbers of cameras located throughout the environments and/or large amounts of space that is occluded from one or more of the cameras.

### BRIEF DESCRIPTION OF THE DRAWINGS

The present systems and methods for three-dimensional multi-camera perception systems and applications are described in detail below with reference to the attached drawing figures, wherein:

FIG. 1A illustrates an example of a first process of performing three-dimensional multi-camera perception to determine three-dimensional information associated with objects, in accordance with some embodiments of the present disclosure;

FIG. 1B illustrates an example of a second process of performing three-dimensional multi-camera perception to determine three-dimensional information associated with objects, in accordance with some embodiments of the present disclosure;

FIG. 2 illustrates an example of an environment that includes cameras located at various locations, in accordance with some embodiments of the present disclosure;

FIGS. 3A-3B illustrate examples of cameras generating image data representing an environment, in accordance with some embodiments of the present disclosure;

FIG. 4 illustrates an example of three-dimensional information that may be output, in accordance with some embodiments of the present disclosure;

FIG. 5 illustrates an example of a process of using three-dimensional information associated with objects to classify the objects, in accordance with some embodiments of the present disclosure;

FIG. 6 illustrates a data flow diagram illustrating a process for training one or more networks to perform three-dimensional multi-camera perception, in accordance with some embodiments of the present disclosure;

FIGS. 7-8 illustrate flow diagrams showing methods for performing three-dimensional multi-camera perception associated with an environment, in accordance with some embodiments of the present disclosure;

FIG. 9 illustrates a flow diagram showing a method for determining birds-eye-view features based at least on multi-view image features, in accordance with some embodiments of the present disclosure;

FIG. 10 illustrates an example architecture where one or more of the processes described herein may be performed, in accordance with some embodiments of the present disclosure;

FIG. 11 is a block diagram of an example computing device suitable for use in implementing some embodiments of the present disclosure; and

FIG. 12 is a block diagram of an example data center suitable for use in implementing some embodiments of the present disclosure.

### DETAILED DESCRIPTION

Systems and methods are disclosed related to three-dimensional multi-camera perception systems and applications. For instance, a system(s) may receive instances of image data generated using cameras located throughout an environment. As described herein, the environment may include an interior environment, such as a retail environment, a warehouse environment, an office environment, an educational environment, and/or any other interior environment, and/or the environment may include an outdoor environment. Additionally, the environment may include static objects that are stationary within the environment, such as shelves, tables, racks, walls, doors, fixtures, furniture, appliances, and/or any other type of static object, as well as dynamic objects that move throughout the environment, such as people, animals, machines (e.g., robots, etc.), and/or any other type of dynamic object. In some examples, the system(s) may continuously be receiving the image data from the cameras. In some examples, the system(s) may receive the image data at given time instances, such as every second, minute, hour, and/or the like. Still, in some examples, the image data may have been previously generated using the cameras and stored in one or more databases for later processing.

As described herein, the cameras may be located throughout the environment such that the cameras include fields-of-view (FOV(s)) that capture different portions of the environment (e.g., the interior of the environment). For example, a first camera may include a first FOV that includes a first portion of the environment, a second camera may include a second FOV that includes a second portion of the environment, a third camera may include a third FOV that includes a third portion of the environment, and/or so forth. Additionally, in some examples, at least some of the cameras may include overlapping FOVs within the environment. For example, the first FOV of the first camera may at least partially overlap with the second FOV of the second camera such that the first camera and the second camera capture a similar portion of the environment. Furthermore, in some examples, such as when cameras include overlapping FOVs, a portion of the environment may be occluded from one of the cameras, but still visible to the other camera. For example, a static object located within the environment may obstruct a portion of the first FOV of the first camera, such that a portion of the environment is not visible to the first camera, but the portion of the environment may still be visible to the second camera.

The system(s) may then process the image data in order to determine information associated with objects located within the environment. As described herein, the information may include, but is not limited to, 3D information (e.g., 3D locations) of the objects within the environment, classifications associated with the objects within the environment, identifiers associated with the objects within the environment, and/or any other information. Additionally, in some examples, 3D information of an object may include, but is not limited to, a 3D point within the environment, a 3D bounding shape (e.g., a bounding box, a bounding cuboid, a bounding cylinder, etc.) within the environment, a 3D pose of the object (e.g., a skeleton, etc.), a 3D shape (e.g., a pole, cylinder, etc.) representing the object, a 3D point representing a location of the object (e.g., a point on the ground, etc.), a relative location with respect to a reference, and/or any other type of 3D information indicating the location of an object within the environment. Furthermore, in some examples, a 3D bounding shape may be represented using one or more parameters, such as three parameters for the scale of the bounding shape (e.g., the length, the width, and the height), three parameters for the center location of the bounding shape (e.g., the x-coordinate location, the y-coordinate location, and the z-coordinate location), two parameters for the yaw of the object (e.g., the cosine angle and the sine angle), and/or two parameters for the velocity of the object (e.g., the velocity in the x-direction and the velocity in the y-direction).

To determine the 3D information, the system(s) may initially process the image data using one or more feature extractors that are configured to generate feature data representing multi-view image features. For example, the system(s) may process the image data using one or more backbones that are configured to generate first feature data associated with first image data generated using the first camera, second feature data associated with second image data generated using the second camera, third feature data associated with third image data generated using the third camera, and/or so forth. In such an example, the first feature data may represent first features associated with a first image depicting the first portion of the environment, the second features data may represent second features associated with a second image depicting the second portion of the environment, the third feature data may represent third features associated with a third image depicting the third portion of the environment, and/or so forth. This is why the feature data may be referred to as representing “multi-view” image features of the environment.

The system(s) may then process the feature data, along with calibration data associated with the cameras within the environment, using one or more spatio-temporal transformers that are configured to determine the 3D information associated with the objects. As described herein, the calibration data for a camera may relate 3D coordinates (e.g., 3D points) within the environment to 2D coordinates (e.g., 2D points) associated with images generated using the camera. For example, and as described in more detail herein, the calibration data for the camera may include a matrix, such as a 3×4 projection matrix, that relates the 3D points within the environment to the 2D points associated with the images. In some examples, the system(s) (and/or another system(s)) may generate the calibration data using one or more inputs indicating information associated with the cameras, such as intrinsic parameters (e.g., focal lengths, principal points, scale factors, etc.) and/or extrinsic parameters (e.g., locations, orientations, etc.) associated with the cameras. In some examples, the system(s) (and/or another system(s)) may automatically generate the calibration data based at least on processing data generated using the cameras.

For more detail about determining the 3D information, the system(s) may use one or more spatial encoders to process the feature data, the calibration data, and/or query data representing one or more queries. Based at least on the processing, the spatial encoder(s) may generate aggregated feature data representing features associated with the environment, which are also referred to as “BEV features.” For instance, the spatial encoder(s) may generate the aggregated feature data by aggregating the features represented by the respective feature data that is associated with the different images of the image data. In some examples, to perform the aggregation, the spatial encoder(s) may use the calibration data to project 3D points associated with the aggregated feature data (e.g., a BEV image) to 2D points associated with the feature data (e.g., images associated with the feature data). The spatial encoder(s) may then use the projections to determine features corresponding the 2D points associated with the feature data and map those features to the 3D points associated with the aggregated feature data.

The system(s) may then use one or more temporal encoders to process the aggregated feature data with respect to one or more additional instances of aggregated feature data associated with one or more previous instances in time. For example, the temporal encoder(s) may be configured to concatenate the aggregated feature data with the previous instance(s) of aggregated feature data in order to generate fused feature data. In some examples, when performing the concatenation, the temporal encoder(s) may model temporal connections between BEV features of different instances of aggregated feature data using one or more temporal self-attention layers in order to construct precise associations between similar objects represented by the aggregated feature data at different time instances. Additionally, details about how the temporal encoder(s) may generate the fused feature data is described in more detail herein.

The system(s) may then process the fused feature data using one or more decoders, such as one or more DETR decoders (and/or any other type of decoder), that are configured to generate data representing the 3D information associated with the objects. For instance, in some examples, the decoder(s) may include one or more self-attention layers and/or one or more cross-attention layers that are alternatively stacked with respect to one another, where the layers are used to process the fused feature data in order to determine the 3D information. However, in other examples, the decoder(s) may include any other types of layers to perform one or more of the processes described herein. Additionally, in some examples, the decoder(s) may use a set of learned embeddings as object queries, where the object queries may indicate locations where target objects may possibly be located within the environment, to determine the 3D information associated with the objects.

In some examples, the system(s) may continue to perform these processes in order to continue generating data representing 3D information associated with objects at different time instances. For instance, the system(s) may generate data for each frame generated using the cameras, every other frame generated using the cameras, every fourth frame generated using the cameras, and/or using any other type of interval. Additionally, in some examples, the system(s) (and/or another system(s)) may then perform one or more operations using the data representing the 3D information. For example, the system(s) may use the data to track one or more of the objects within the environment, determine 2D information associated with one or more objects (e.g., determine 2D bounding shapes associated with the objects within the images), determine additional 3D information associated with one or more objects (e.g., determine 3D bounding shapes associated with the objects as represented by the images), determine one or more classifications associated with one or more objects, and/or perform any other operation. While these are just a few examples of additional processes that the system(s) may perform using the data, in other examples, the system(s) may perform additional and/or alternative processes using the data.

As described herein, by performing these processes to determine the 3D locations associated with the objects, the system(s) may not need to initially determine 2D locations associated with the objects within the images and/or may not need to project the 2D locations from the images to the 3D space associated with the environment. As such, the system(s) described herein may more accurately determine the 3D locations associated with the objects by removing detection and/or projection errors. Additionally, these improvements may be more prevalent in certain environments, such as complex environments that include numerous cameras monitoring interiors of the environments and/or environments that include large areas that are occluded from at least some of the cameras. For instance, by initially determining the multi-view image features associated with the images and then using the multi-view image features to determine the BEV features associated with the environment, the system(s) is able to process image data from numerous cameras while also capturing features associated with objects that may be occluded from some cameras, but visible to other cameras.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems implementing large language models (LLMs), systems implementing small language models (SLMs), systems implementing vision language models (VLMs), systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

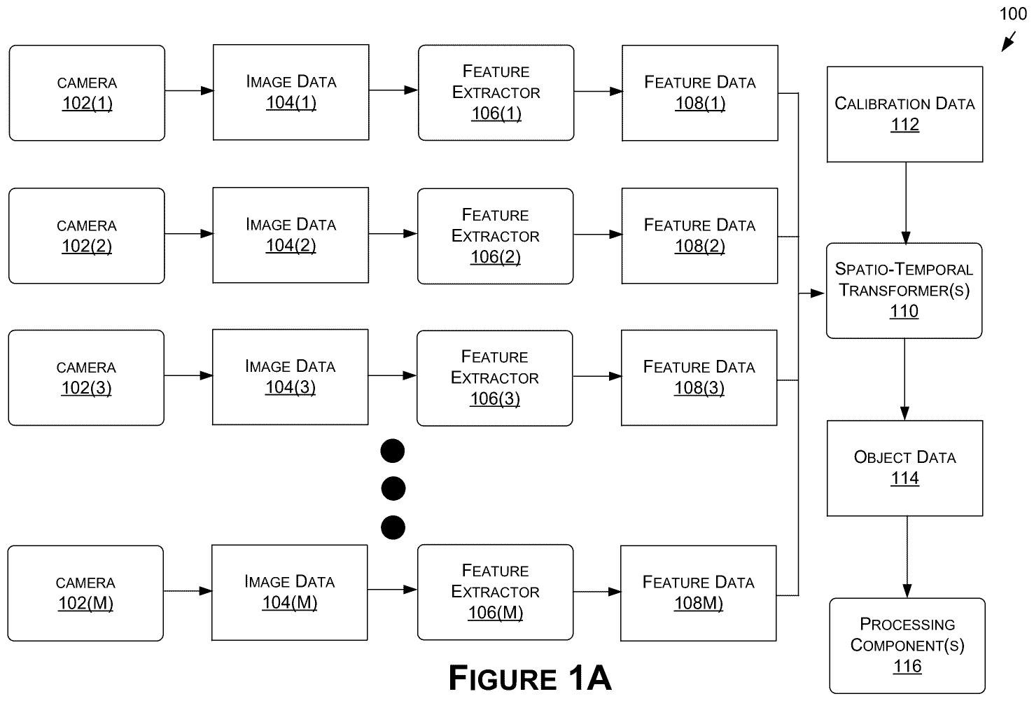

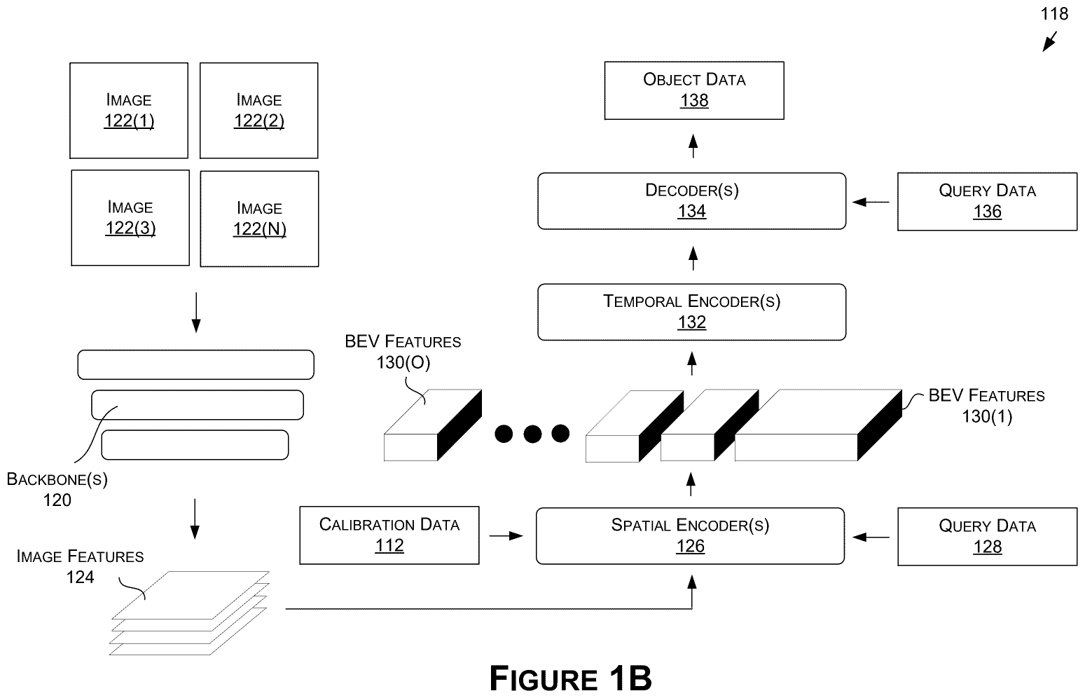

With reference to FIG. 1A, FIG. 1A illustrates an example of a first process of performing three-dimensional multi-camera perception to determine 3D information associated with objects, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

The process 100 may include cameras 102(1)-(M) (also referred to singularly as “camera 102” or in plural as “cameras 102”) generating image data 104(1)-(M) (also referred to as “image data 104”). As described herein, in some examples, the cameras 102 may be located throughout an environment, such as a retail environment, a warehouse environment, an office environment, an educational environment, an outdoor environment, and/or any other type of environment. Additionally, the cameras 102 may be located throughout the environment such that the cameras 102 include fields-of-view (FOV(s)) that capture different portions of the environment (e.g., the interior of the environment). For example, the first camera 102(1) may include a first FOV that includes a first portion of the environment, the second camera 102(2) may include a second FOV that includes a second portion of the environment, the third camera(s) 102(3) may include a third FOV that includes a third portion of the environment, and/or so forth to the final camera(s) 102(M) that includes a final FOV that includes a final portion of the environment.

Additionally, in some examples, at least some of the cameras 102 may include overlapping FOVs within the environment. For example, the first FOV of the first camera 102(1) may at least partially overlap with the second FOV of the second camera 102(2) such that the first camera 102(1) and the second camera 102(2) capture a similar portion of the environment. Furthermore, in some examples, such as when cameras 102 include overlapping FOVs, a portion of the environment may be occluded from one of the cameras 102, but still visible by the other camera 102. For instance, a static object located within the environment may obstruct a portion of the first FOV of the first camera 102(1), such that a portion of the environment is not visible to the first camera 102(1), but the portion of the environment may still be visible to the second FOV of the second camera 102(2).

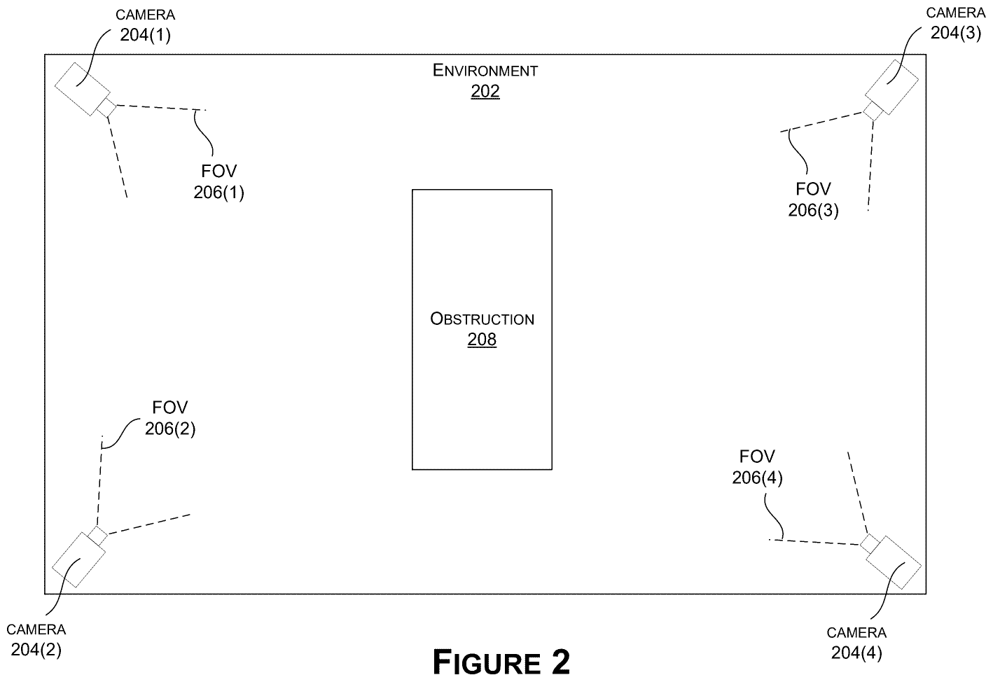

For instance, FIG. 2 illustrates an example of an environment 202 that includes cameras 204(1)-(4) (also referred to singularly as “camera 204” or in plural as “cameras 204”) located at various locations, in accordance with some embodiments of the present disclosure. As shown, the first camera 204(1) (which may represent the first camera 102(1)) may be located at a first location and include a first FOV 206(1) of the environment 202, the second camera 204(2) (which may represent the second camera 102(2)) may be located at a second location and include a second FOV 206(2) of the environment 202, the third camera 204(3) (which may represent the third camera 102(3)) may be located at a third location and include a third FOV 206(3) of the environment 202, and the fourth camera 204(4) (which may represent the final camera 102(M)) may be located at a fourth location and include a fourth FOV 206(4) of the environment 202.

In some examples, one or more of the FOVs 206(1)-(4) may at least partially overlap with one another. For example, each of the FOVs 206(1)-(4) may include at least a portion of the environment 202, such as a center portion of the environment 202. However, the FOVs 206(1)-(2) of the cameras 204(1)-(2) may be partially occluded by an obstruction 208 (e.g., a static object) such that the cameras 204(1)-(2) may not capture a portion of the environment 202 that is to a right side of the obstruction 208. Additionally, the FOVs 206(3)-(4) of the cameras 204(3)-(4) may be partially occluded by the obstruction 208 such that the cameras 204(3)-(4) may not capture a portion of the environment 202 that is to a left side of the obstruction 208.

In some examples, the environment 202 may include a complex environment, such as a warehouse environment, a retail environment, an educational environment, and/or any other type of environment. Additionally, in such examples, the environment 202 represented by the example of FIG. 2 may include an interior that is within the four sides of the environment 202, where the FOVs 206(1)-(4) of the cameras 204 include different portions of the interior of the environment 202. Additionally, in some examples, the cameras 204 may be stationary within the environment 202 such that the locations of the cameras 204 do not change and/or do not substantially change. This way, after the cameras 204 are calibrated, which is described in more detail herein, the calibration information may relate the same 3D points within the environment 202 to 2D points associated with images generated using the cameras 204 over periods of time.

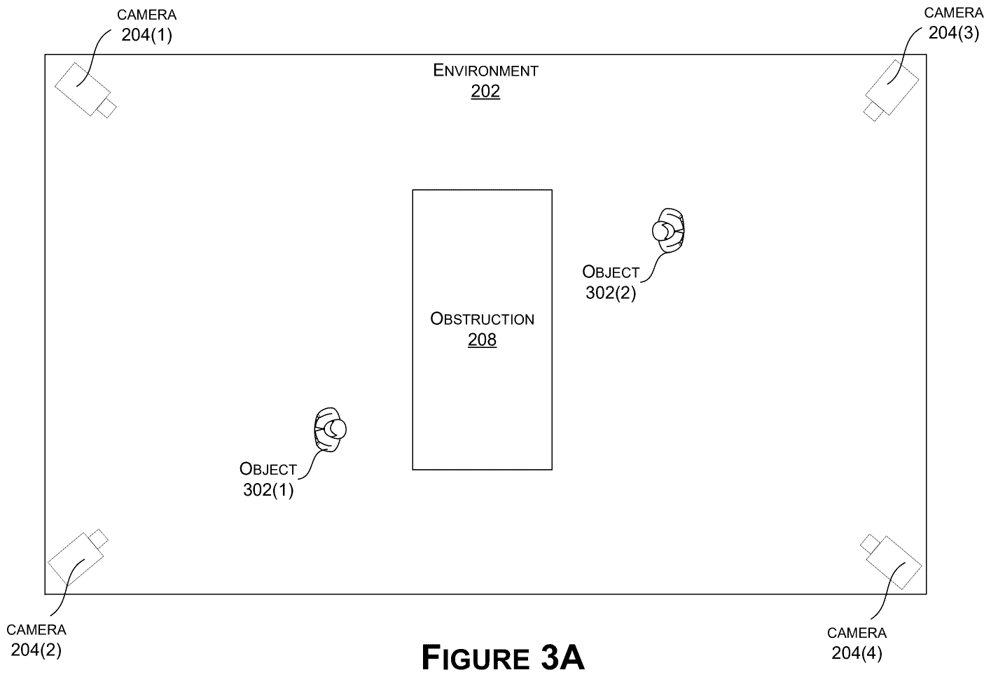

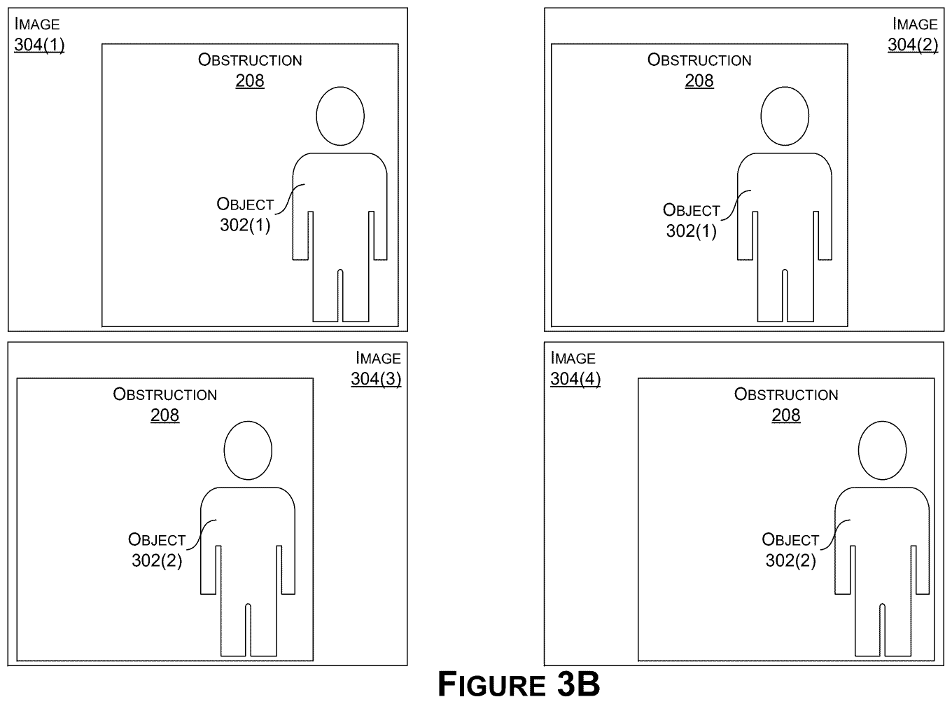

FIGS. 3A-3B illustrate examples of the cameras 204 generating image data representing the environment 202, in accordance with some embodiments of the present disclosure. As shown by the example of FIG. 3A, at least a first object 302(1) and a second object 302(2) may be located within the environment 202. While the example of FIG. 3A illustrates the objects 302(1)-(2) as including people, in other examples, the objects may include any other type of object, such as machines, robots, animals, and/or the like. The first camera 204(1) may then generate first image data (e.g., the first image data 104(1)), the second camera 204(2) may generate second image data (e.g., the second image data 104(2)), the third camera 204(3) may generate third image data (e.g., the third image data 104(3)), and the fourth camera 204(4) may generate fourth image data (e.g., the final image data 104(M)).

For instance, as shown by the example of FIG. 3B, the first image data generated using the first camera 204(1) may represent a first image 304(1), where the first image 304(1) depicts at least the first object 302(1). However, the second object 302(2) may be occluded by the obstruction 208 in the first image 304(1). Additionally, the second image data generated using the second camera 204(2) may represent a second image 304(2), where the second image 304(2) also depicts the first object 302(1). However, similar to the first image 304(1), the second object 302(2) may be occluded by the obstruction 208 in the second image 304(2). Furthermore, the third image data generated using the third camera 204(3) may represent a third image 304(3), where the third image 304(3) depicts at least the second object 302(2). However, the first object 302(1) may be occluded by the obstruction 208 in the third image 304(3). Furthermore, the fourth image data generated using the fourth camera 204(4) may represent a fourth image 304(4), where the fourth image 304(4) also depicts the second object 302(2). However, similar to the third image 304(3), the first object 302(1) may be occluded by the obstruction 208 in the fourth image 304(4).

Referring back to the example of FIG. 1A, the process 100 may include using feature extractors 106(1)-(M) (also referred to singularly as “feature extractor 106” or in plural as “feature extractors 106”) to process the image data 104. As described herein, a feature extractor 106 may include, but is not limited to, one or more backbones, one or more layers of a neural network, one or more neural networks, one or more encoders, one or more decoders, and/or any other type of processing components that is configured to perform one or more of the processes described herein. As shown, based at least on processing the image data 104, the process 100 may include the feature extractors 106 generating feature data 108(1)-(M) (also referred to as “feature data 108”). For instance, the first feature extractor 106(1) may generate the first feature data 108(1) that represents first features associated with the first image represented by the first image data 104(1), the second feature extractor 106(2) may generate the second feature data 108(2) that represents second features associated with the second image represented by the second image data 104(2), the third feature extractor 106(3) may generate the third feature data 108(3) that represents third features associated with the third image represented by the third image data 104(3), and the final feature extractor 106(M) may generate the final feature data 108(M) that represents final features associated with the final image represented by the final image data 104(M).

The process 100 may then include one or more spatio-temporal transformers 110 processing the feature data 108 and/or calibration data 112. As described in more detail herein, and as illustrated by the example of FIG. 1B, the spatio-temporal transformer(s) 110 may include and/or use one or more spatial encoders, one or more temporal encoders, one or more decoders, one or more layers of one or more neural networks, one or more neural networks, and/or any other type of processing component that is configured to perform at least a portion of the processes described herein. Additionally, the calibration data 112 for a camera 102 may relate 3D coordinates (e.g., 3D points) within the environment to 2D coordinates (e.g., 2D points) associated with images generated using the camera 102. For instance, the calibration data 112 for the camera 102 may include a matrix, such as a 3×4 projection matrix, that relates the 3D points within the environment to the 2D points associated with the images.

For an example of a matrix, a camera perspective projection may be written as a linear mapping between homogenous coordinates using:

$$[ \begin{matrix}{x}_{c} \\ {y}_{c} \\ f\end{matrix} ] = [ \begin{matrix}1 & 0 & 0 & 0 \\ 0 & 1 & 0 & 0 \\ 0 & 0 & 1 & 0\end{matrix} ] [ \begin{matrix}{X}_{c} \\ {Y}_{c} \\ {Z}_{c} \\ 1\end{matrix} ] \qquad ( 1 )$$

In equation (1), the 3×4 projection matrix represents a map from 3D coordinates to 2D coordinates.

Additionally, for an image, intrinsic parameters and/or extrinsic parameters may be added to the projection matrix. For instance, a camera calibration matrix may include:

$$C = [ \begin{matrix}{α}_{u} & 0 & {u}_{0} \\ 0 & {α}_{v} & {v}_{0} \\ 0 & 0 & 1\end{matrix} ] \qquad ( 2 )$$

In equation (2), aᵤ=fkᵤ and aᵥ=−fkᵥ, where k are pixels, aᵤ is the scaling in the image in the x-coordinate direction, ay is the scaling in the image in the y-coordinate direction, and (u₀, v₀) is a principal point for which the optic axis intersects the image plane.

As such, the Euclidean transformation between the camera and world coordinates may include X_{c}=RX_{w}+T, where:

$$[ \begin{matrix}{X}_{c} \\ {Y}_{c} \\ {Z}_{c} \\ 1\end{matrix} ] = [ \begin{matrix}R & T \\ {0}^{⊤} & 1\end{matrix} ] [ \begin{matrix}{X}_{w} \\ {Y}_{w} \\ {Z}_{w} \\ 1\end{matrix} ] \qquad ( 3 )$$

Additionally, when concatenating the three matrices, the following is formed:

$$x = [ \begin{matrix}u \\ v \\ 1\end{matrix} ] = C [ \begin{matrix}1 & 0 & 0 & 0 \\ 0 & 1 & 0 & 0 \\ 0 & 0 & 1 & 0\end{matrix} ] [ \begin{matrix}R & T \\ {0}^{⊤} & 1\end{matrix} ] [ \begin{matrix}{X}_{w} \\ {Y}_{w} \\ {Z}_{w} \\ 1\end{matrix} ] = C [ R \vert T ] \qquad ( 4 )$$

Equation (4) then defines a 3×4 projection matrix from Euclidean 3-space to an image by the following:

$$x = P [ \begin{matrix}X \\ 1\end{matrix} ] \qquad ( 5 )$$

$$P = C [ R \vert T ] \qquad ( 6 )$$

While this is just one example of a projection matrix that may be represented by the calibration data 112, in other examples, the calibration data 112 may represent one or more additional and/or alternative matrices that relate the 3D points within the environment to the 2D points associated with the images generated using the cameras 102.

Additionally, in some examples, the calibration data 112 may represent additional information associated with the cameras 102. For instance, and as described herein, at least a portion of one or more of the cameras 102 may be occluded by one or more objects located within the environment, such as one or more static objects. As such, in some examples, if a portion of a camera 102 is occluded, the calibration data 112 may represent the portion of the environment that is occluded. For example, the calibration data 112 may represent a 2D location within images generated using the camera 102 that is occluded. In such an example, the 2D location may include, but is not limited to, 2D point (e.g., 2D pixel) locations, a bounding shape, and/or any other type of 2D location.

The process 100 may then include the spatio-temporal transformer(s) 110 generating and/or outputting object data 114 representing 3D information associated with one or more objects located within the environment. For instance, and as described herein, the object data 114 may represent at least one or more 3D locations associated with the object(s) located within the environment. In some examples, a 3D location may be represented using one or more parameters, such as three parameters for the scale of a bounding shape (e.g., the length, the width, and the height), three parameters for the center location of the bounding shape (e.g., the x-coordinate location, the y-coordinate location, and the z-coordinate location), two parameters for the yaw of the object (e.g., the cosine angle and the sine angle), and/or two parameters for the velocity of the object (e.g., the velocity in the x-direction and the velocity in the y-direction).

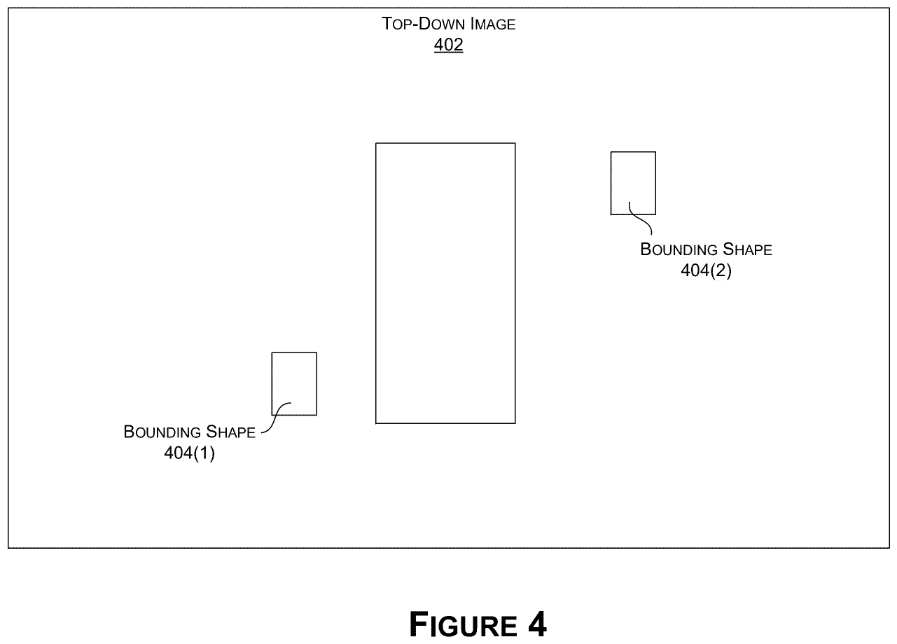

For instance, FIG. 4 illustrates an example of 3D information that may be output, in accordance with some embodiments of the present disclosure. As shown by the example of FIG. 4, output data (e.g., the object data 114) may represent a top-down image 402 (e.g., a BEV image) of the environment 202 that includes at least a first 3D location associated with the first object 302(1), where the first 3D location includes a first bounding shape 404(1) (e.g., a 3D bounding shape, where the third dimension is towards the ground plane), and a second 3D location associated with the second object 302(2), where the second 3D location includes a second bounding shape 404(2) (e.g., a 3D bounding shape, where the third dimension is towards the ground plane). While the example of FIG. 4 illustrates the 3D locations as including bounding shapes, in other examples, the output data may represent any other type of 3D locations associated with one or more of the objects 302(1)-(2). Additionally, while the example of FIG. 4 illustrates the output data as representing the top-down image 402 with the indicated 3D locations, in other examples, the output data may just represent the 3D locations (e.g., the 3D coordinates associated with the 3D locations).

Referring back to the example of FIG. 1A, in some examples, the process 100 may then continue to repeat as the cameras 102 continue generating new image data 104 representing the environment. For instance, the process 100 may repeat such that object data 114 is generated for each frame generated using the cameras 102, every other frame generated using the cameras 102, every fourth frame generated using the cameras 102, and/or using any other interval associated with the frames generated using the cameras 102.

As further shown by the example of FIG. 1A, the process 100 may include one or more processing components 116 performing one or more operations using the object data 114. For instance, and as described herein, the operation(s) may include, but is not limited to, tracking one or more of the objects within the environment, determining 2D information associated with one or more objects (e.g., determining 2D bounding shapes associated with the objects as represented by the images), determining additional 3D information associated with one or more objects (e.g., determining 3D bounding shapes associated with the images), determining one or more classifications associated with one or more objects, and/or performing any other operation.

For more details, the processing component(s) 116 may be used to track one or more objects located within the environment. For instance, the processing component(s) 116 may use at least a portion of the object data 114 (e.g., the 3D information) and the calibration data 112 (e.g., the camera calibration information) to project the 3D locations (e.g., the 3D bounding shapes) associated with the objects to 2D locations (e.g., 2D bounding shapes, such as 2D bounding boxes) within the images as represented by the image data 104. In some examples, to perform the projections, the processing component(s) 116 may initially determine pixels of the images that are associated with the 3D locations. The processing component(s) 114 may then generate the 2D bounding shapes within the images using the pixels. Additionally, the processing component(s) 114 may associate the 3D bounding shapes with the 2D bounding shapes using one or more techniques, such as by using one or more algorithms (e.g., the Hungarian Algorithm, etc.).

The processing component(s) 116 may then use the 2D locations to track the objects. For example, the processing component(s) 116 may use one or more machine learning models to track the 2D locations of the objects between images over a period of time (e.g., 10 seconds, 30 seconds, 1 minute, 5 minutes, etc.). In some examples, the machine learning model(s) may track the 2D locations based at least on extracting appearance features (e.g., generating embeddings) associated with the 2D locations (e.g., the 2D bounding shapes) and then using the extracted appearance features to track the objects (e.g., determining that embeddings are similar and/or related between the images). Additionally, in some examples, the processing component(s) 116 may track the objects within the 3D environment, such as by associating again the 3D locations (e.g., the 3D bounding shapes) with the 2D locations (e.g., the 2D bounding shapes.

As described herein, the feature extractors 106 and/or the spatio-temporal transformer(s) 110 may use any type of processing component to perform one or more of the processes described herein. For instance, FIG. 1B illustrates an example of a second process 118 of performing three-dimensional multi-camera perception to determine 3D information associated with objects, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

As shown, the process 118 may include one or more backbones 120 processing image data representing at least images 122(1)-(N) (also referred to singularly as “image 122” or in plural as “images 122”). In some examples, the images 122 may be represented by the image data 104 from the example of FIG. 1A. For example, the first image 122(1) may be represented by the first image data 104(1), the second image 122(2) may be represented by the second image data 104(2), the third image 122(3) may be represented by the third image data 104(3), and/or the final image 122(N) may be represented by the final image data 104(M). In other words, each of the images 122 may be generated using a respective camera 102 located within an environment. Additionally, in some examples, the images 122 may be generated at a substantially same time such that the images 122 depict the environment in a similar state (e.g., the objects in the environment are located in similar locations and/or orientations within the environment).

In the example of FIG. 1B, the backbone(s) 120 may include any type of backbone network, such as a residual neural network (ResNet), VoVNet, ImageNet, Deep Layer Aggression (DLA), a transformer-based foundation backbone (e.g., DINO, Swin, etc.), a convolutional neural network, and/or any other type of backbone network. As such, the process 118 may include the backbone(s) 120 processing the images 122 and, based at least on the processing, generating feature data representing multi-view image features 124. For instance, the backbone(s) 120 may generate first feature data that represents first features 124 associated with the first image 122(1), second feature data that represents second features 124 associated with the second image 122(2), third feature data that represents third features 124 associated with the third image 122(3), and final feature data that represents final features 124 associated with the final image 122(N).

The process 118 may then include one or more spatial encoders 126 processing the multi-view image features, the calibration data 112, and/or query data 128. In some examples, the query data 128 may represent one or more queries (e.g., one or more BEV queries) that are associated with one or more features, such as one or more features for which 3D information is being generated. The process 118 may then include, based at least on the processing, the spatial encoder(s) 126 generating and/or outputting current BEV features 130(1) associated with the multi-view image features 124. As described herein, in some examples, the spatial encoder(s) 126 may use the calibration data 112 to project the multi-view image features 124 in order to generate the current BEV features 130(1).

For instance, the spatial encoder(s) 126 may be configured to sample 3D reference points associated with the environment and then project the 3D reference points to the 2D views of the images 122 using the calibration data 112. In some examples, for a query represented by the query data 128, projected 2D points may fall on one or more of the 2D views at one or more 2D points, which may be referred to as the reference point(s). The spatial encoder(s) 126 may then sample the features 124 from the reference point(s) and/or one or more points that at least partially surround the reference point(s) and output the sampled features 124 as the spatial cross-attention. In some examples, when outputting the sampled features 124 as the spatial cross-attention, the spatial encoder(s) 126 may perform a weighted sum of the sampled features.

In some examples, when sampling the features, the spatial encoder(s) 126 may perform various techniques to obtain the reference points in the images 122. For example, the spatial encoder(s) 126 may lift each query Q on a BEV plane to a pillar-like query, sample N_{ref} 3D reference points from the pillar, and then project these points to 2D views. For one BEV query, the projected 2D points may fall on some view while also not falling on other views. As such, the hit views may be termed as Vₕᵢₜ. After that, the spatial encoder(s) 126 may regard the 2D points as the reference points of a query Qₚ and sample the features from the hit views Vₕᵢₜ around these reference points. Finally, the spatial encoder(s) 126 may perform a weighted sum of the sampled features points as the output of spatial cross-attention, where the process of spatial cross-attention (SCA) may be formulated as the following:

$$SCA ( {Q}_{p} , {F}_{t} ) = \frac{1}{\vert {V}_{hit} \vert} {\sum }_{i ∈ {V}_{h i t}} {\sum }_{j = 1}^{{N}_{ref}} DeformAttn ( {Q}_{p} P ( p , i , j ) , {F}_{t}^{i} \qquad ( 7 )$$

In equation (7), i may index the camera view, j may index the reference points, and N_{ref} may be the total reference points for the BEV query. Additionally, Fₜⁱ may be the features in the i-th camera view. As such, for each query, a projection function P (p, i, j) may be used to get the j-th reference point on the i-th view image.

In 3D space, the objects located at (x′, y′) may appear at a height of z′ on the z-axis. As such, in some examples, a set of anchor heights {zⱼ′}ⱼ₌₁^{N}^{_{ref}} may be predefined in order to capture objects that appeared at different heights. As such, for each query, a pillar of 3D reference points (x′, y′, z′)ⱼ₌₁^{N}^{_{ref}} ref may be obtained. Finally, the spatial encoder(s) 126 my project the 3D points to different image views through the projection matrices of cameras, which may be written as:

$$P ( p , i , j ) = ( {x}_{ij} , {y}_{ij} ) \qquad ( 8 )$$

$$where {z}_{ij} \cdot {[ \begin{matrix}{x}_{ij} & {y}_{ij} & 1\end{matrix} ]}^{T} = {{T}_{i} [ \begin{matrix}{x}^{′} & {y}^{i} & {z}_{j}^{′} & 1\end{matrix} ]}^{T}$$

In equation (8), P(p,i,j) is the 2D point on the i-th view projected from the j-th 3D point (x′, y′, zⱼ′) and Tᵢ∈ [symbol] ^{3×4} is the known projection matrix (e.g., from above) of the i-th camera.

The process 118 may then include one or more temporal encoders 132 processing the current BEV features 130(1) along with one or more previous BEV features 130(O) associated with one or more previous time instances, such as time instances associated with images previously generated using the cameras. For instance, in some examples, the temporal encoder(s) 132 may be configured to associate BEV features 130(1)-(O) between different time instances. In some examples, the temporal encoder(s) 132 may use one or more techniques to perform these associations, such as by modeling temporal connections between BEV features 130(1)-(O) through one or more self-attention layers.

Additionally, or alternatively, in some examples, the temporal encoder(s) 132 may use a warp and concatenate strategy to perform the temporal encoding. For instance, given a BEV feature at a different frame (e.g., a previous BEV feature 130(O)), the temporal encoder(s) 132 may warp the BEV feature into the current frame (e.g., the current BEV feature 130(1)) according to a reference frame transformation matrix between the previous frame and the current frame. Next, the temporal encoder(s) 132 may concatenate previous BEV features 130(O) with current BEV features 130(1) along the channel dimension to employ residual blocks for dimension reduction. While these are just a few example techniques for how the temporal encoder(s) 132 may perform the temporal encoding using the BEV features 130(1)-(O), in other examples, the temporal encoder(s) 132 may use any other technique.

The process 118 may then include one or more decoders 134 processing the output from the temporal encoder(s) 132 and/or query data 136. As described herein, in some examples, the query data 136 may represent one or more queries indicating where target objects may possibly be located, where the one or more queries may be learned through training. Additionally, the decoder(s) 134 may include any type of decoder, such as a detection transformer (DETR) decoder, a binary decoder, an image decoder, and/or any other type of decoder.

The process 118 may then include, based at least on processing the output from the temporal encoder(s) 132 and/or the query data 136, the decoder(s) 134 generating and/or outputting object data 138 (which may be similar to, and/or represent, the object data 114) representing 3D information associated with one or more objects. For instance, and as described herein, the object data 114 may represent at least one or more 3D locations associated with the object(s) located within the environment.

For more details about the decoder(s) 134, in some examples, the decoder(s) 134 may include one or more self-attention layers and one or more cross-attention layers that are alternatively stacked with respect to one another. The cross-attention layer(s) may then take, as input, (1) query features to produce sampling offsets and attention weights, (2) 2D points on the value feature as sampling reference for each query, and (3) the BEV features output by the temporal encoder(s) 132. The decoder(s) 134 may then process the inputs and, based at least on the processing, determine projected box centers on a BEV plain that are used as per-image reference points, where the per-image reference points may indicate the possible positions of objects in the BEV plain. As such, the decoder(s) 134 may use these per-image reference points to determine the 3D information associated with the objects.

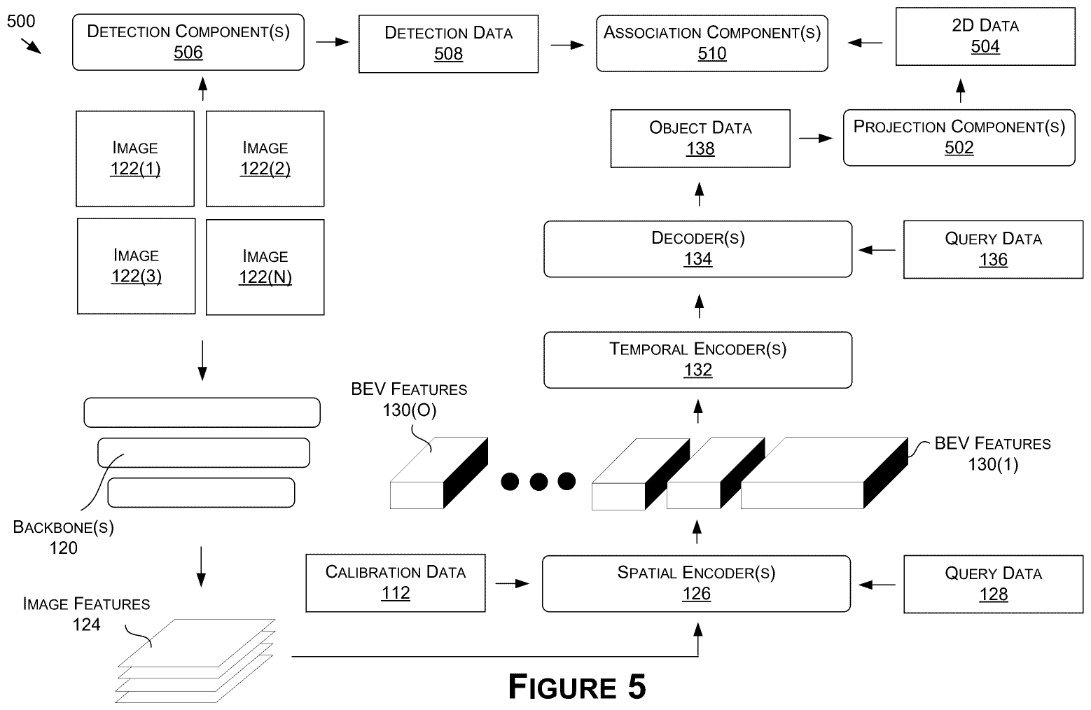

As described herein, in some examples, additional processing may be performed with respect to the 3D information, such as processing to classify objects. For instance, FIG. 5 illustrates an example of a process of using 3D information associated with objects to classify the objects, in accordance with some embodiments of the present disclosure. As shown, the process 500 may initially include performing at least a portion of the process 118 to generate the object data 138 representing the 3D locations associated with the objects. However, the process 500 may then include one or more projection components 502 further processing the object data 138 in order to generate 2D data 504 representing 2D information associated with the objects. For instance, in some examples, the projection component(s) 502 may project the 3D locations associated with the objects to 2D locations within the images 122, where the 2D data 504 represents the 2D locations. As described herein, in some examples, the 2D locations may include bounding shapes (e.g., bounding boxes, etc.) associated with the objects.

The process 500 may further include one or more detection components 506 processing at least a portion of the image data representing the images 122. As described herein, the detection component(s) 506 may include and use one or more machine learning models, one or more neural networks, one or more algorithms, and/or any other type of processing component that is configured to perform one or more of the processes described herein. Based at least on the processing, the process 500 may include the detection component(s) 506 generating and/or outputting detection data 508 associated with the objects. For instance, the detection data 508 may represent at least locations associated with the objects within the images 122, identifiers associated with the objects, classifications associated with the objects, and/or any other information.

As described herein, in some examples, an identifier may include, but is not limited to, a numerical identifier, an alphabetic identifier, an alphanumeric identifier, and/or any other type of identifier that may be used to identify an object. Additionally, in some examples, the detection component(s) 506 may initially assign an identifier to an object when the object is first detected, such as in an image 122. The detection component(s) 506 may then continue to assign the same identifier to the object as the object is detected in additional images 122, such as images 122 that represent different views of the object and/or images 122 that are later generated using the cameras.

The process 500 may then include one or more association components 510 using the 2D data 504 and the detection data 508 to associate the identifiers with the 2D locations of the objects within the images. This way, the process 118 of FIG. 1B (and/or the process 100 of FIG. 1A) may initially be used to determine precise locations of the objects within the images 122 and then postprocessing may be used to track identifiers associated with the objects within the images 122.

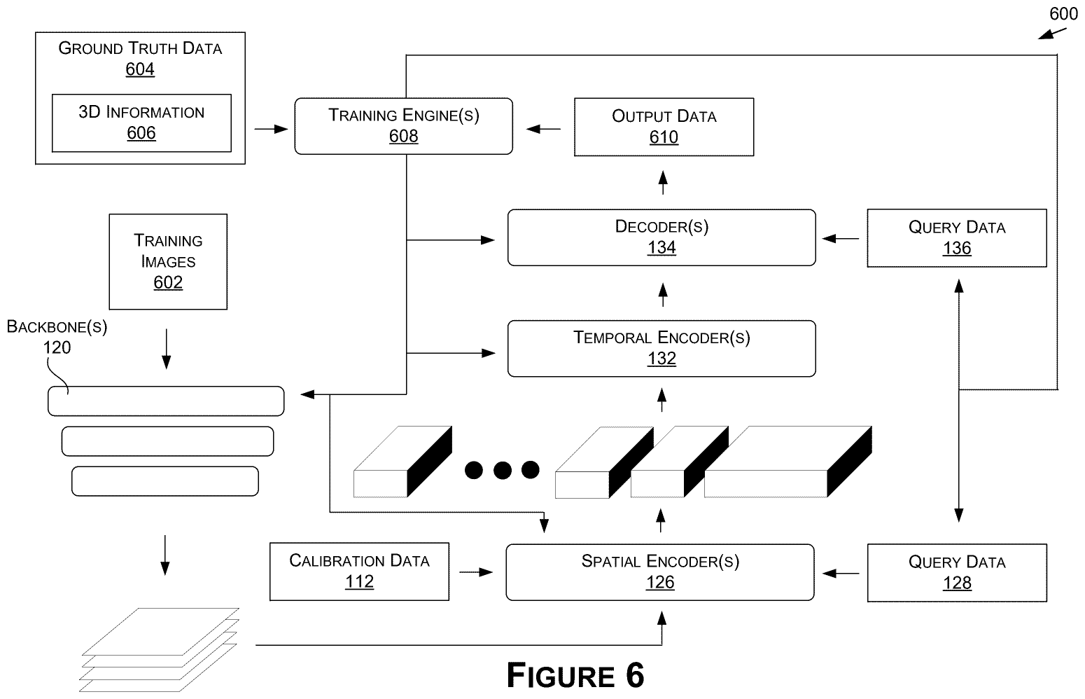

FIG. 6 illustrates a data flow diagram illustrating a process for training one or more networks to perform three-dimensional multi-camera perception, in accordance with some embodiments of the present disclosure. As shown in the process 600, the training may include inputting training images 602 into the backbone(s) 120. In some examples, the training images 602 may be generated using multiple cameras located at various locations within one or more environments and/or may be generated over a period of time. For example, the training images 602 may correspond to videos that are generated by the cameras over a second, five seconds, ten seconds, twenty seconds, one minute, and/or any other period of time. In some examples, the training images 602 may be synthetically produced (e.g., generated from computer models or renderings), real produced (e.g., designed and produced from real-world data, such as image data generated using cameras), machine-automated, and/or a combination thereof.

The training may further include using ground truth data 604 that corresponds to the training images 602. The ground truth data 604 may include annotations, labels, masks, and/or the like. For instance, and as shown, the ground truth data 604 may include at least 3D information 606 associated with objects that are represented by the training images 602 The ground truth data 604 may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines the location of the labels), and/or a combination thereof. In some examples, for each instance of the training images 602, there may be corresponding ground truth data 604.

As further illustrated in the example of FIG. 6, one or more training engines 608 may use one or more loss functions that measure loss (e.g., error) in output data 610 as compared to the ground truth data 604. In some examples, the output data 610 may be similar to and/or include the object data 114 and/or the object data 138. For example, the output data 610 may represent at least 3D information associated with the objects, where the 3D information is determined using one or more of the processes described herein. In some examples, the training engine(s) 608 may use any type of loss function, such as cross entropy loss, mean squared error, mean absolute error, mean bias error, and/or other loss function types. In some examples, different outputs may have different loss functions. In such examples, the loss functions may be combined to form a total loss (where one or more losses may be weighted), and the total loss may be used to train the backbone(s) 120, the spatial encoder(s) 126, the temporal encoder(s) 132, and/or the decoder(s) 134. Additionally, in some examples, the training engine(s) 608 may update the query data 128 and/or the query data 136 based at least on the total loss. In any example, backward pass computations may be performed to recursively compute gradients of the loss function(s) with respect to training parameters. In some examples, weights and/or biases may be used to compute these gradients.

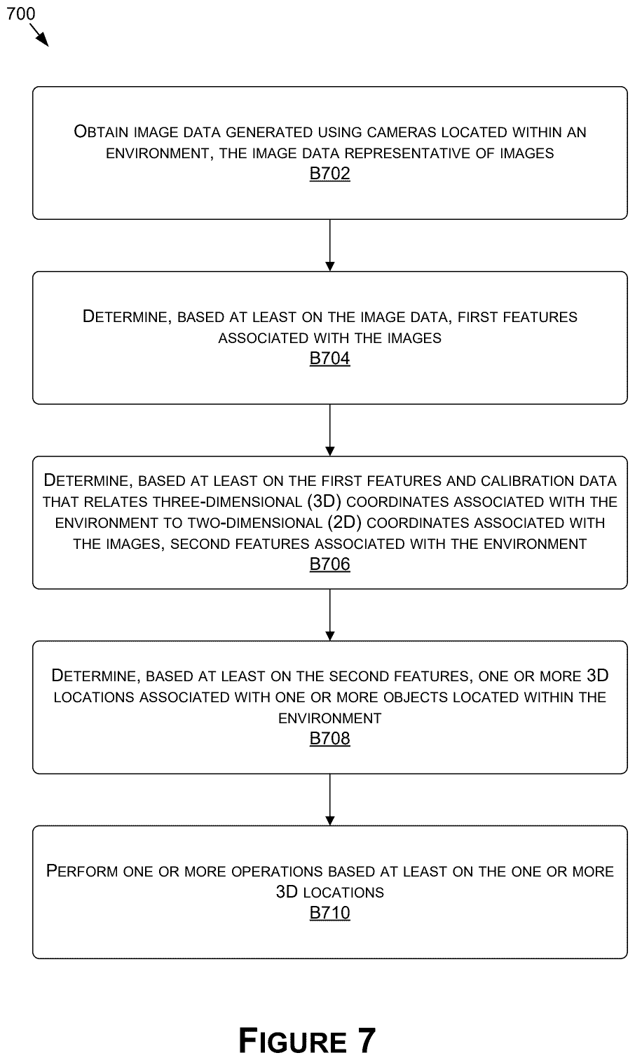

Now referring to FIGS. 7-9, each block of methods 700, 800, and 900 described herein, comprises a computing process that may be performed using any combination of hardware, firmware, and/or software. For instance, various functions may be carried out by a processor executing instructions stored in memory. The methods 700, 800, and 900 may also be embodied as computer-usable instructions stored on computer storage media. The methods 700, 800, and 900 may be provided by a standalone application, a service or hosted service (standalone or in combination with another hosted service), or a plug-in to another product, to name a few. In addition, the methods 700, 800, and 900 are described, by way of example, with respect to FIGS. 1A-1B. However, these methods 700, 800, and 900 may additionally or alternatively be executed by any one system, or any combination of systems, including, but not limited to, those described herein.

FIG. 7 illustrates a flow diagram showing a method 700 for performing three-dimensional multi-camera perception associated with an environment, in accordance with some embodiments of the present disclosure. The method 700, at block B702, may include obtaining image data generated using cameras located within an environment, the image data representative of images. For instance, the cameras 102 located throughout an environment may generate the image data 104 representing the images 122. As described herein, in some examples, the cameras 102 may be located at different locations within the environment and/or may include different orientations within the environment such that the cameras 102 include different FOVs of the environment. Additionally, in some examples, at least some of the FOVs of the cameras 102 may overlap with one another.

The method 700, at block B704, may include determining, based at least on one or more backbones processing the image data, first features associated with the images. For instance, the backbone(s) 120 (and/or the feature extractors 106) may process the image data 104 representing the images 122. Based at least on the processing, the backbone(s) 120 may generate feature data 108 representing the multi-view image features 124 associated with the images 122. For instance, in some examples, the backbone(s) 120 may generate respective feature data 108 that represents one or more image features for each image 122.

The method 700, at block B706, may include determining, based at least on the first features and calibration data that relates three-dimensional (3D) coordinates associated with the environment to two-dimensional (2D) coordinates associated with the images, second features associated with the environment. For instance, the spatial encoder(s) 126 (and/or the spatio-temporal transformer(s) 110) may process the feature data 108 representing the multi-view image features 124 and the calibration data 112 in order to determine the current BEV features 130(1) associated with the images 122. As described herein, in some examples, the spatial encoder(s) 126 may process additional data, such as the query data 128, to determine the current BEV features 130(1).

The method 700, at block B708, may include determining, based at least on the second features, one or more 3D locations associated with one or more objects located within the environment. For instance, the decoder(s) 134 (and/or the spatio-temporal transformer(s) 110) may determine the 3D location(s) associated with the object(s) based at least on the current BEV feature(s) 130(1). In some examples, and as described herein, the temporal encoder(s) 132 (and/or the spatio-temporal transformer(s) 110) may initially associate (e.g., concatenate, combine, etc.) the current BEV features 130(1) with one or more previous BEV features 130(O). In such examples, the decoder(s) 134 may then process the associated BEV features 130(1)-(O) to determine the 3D location(s) associated with the object(s).

The method 700, at block B710, may include performing one or more operations based at least on the one or more 3D locations. For instance, the processing component(s) 116 may perform the operation(s) using the object data 114 representing the 3D location(s) associated with the object(s). As described herein, the operation(s) may include, but is not limited to, tracking one or more of the objects within the environment, determining 2D information associated with one or more objects (e.g., determining 2D bounding shapes associated with the objects within the images), determining additional 3D information associated with one or more objects (e.g., determining 3D bounding shapes associated with the objects as represented by the images), determining one or more classifications associated with one or more objects, and/or any other operation.

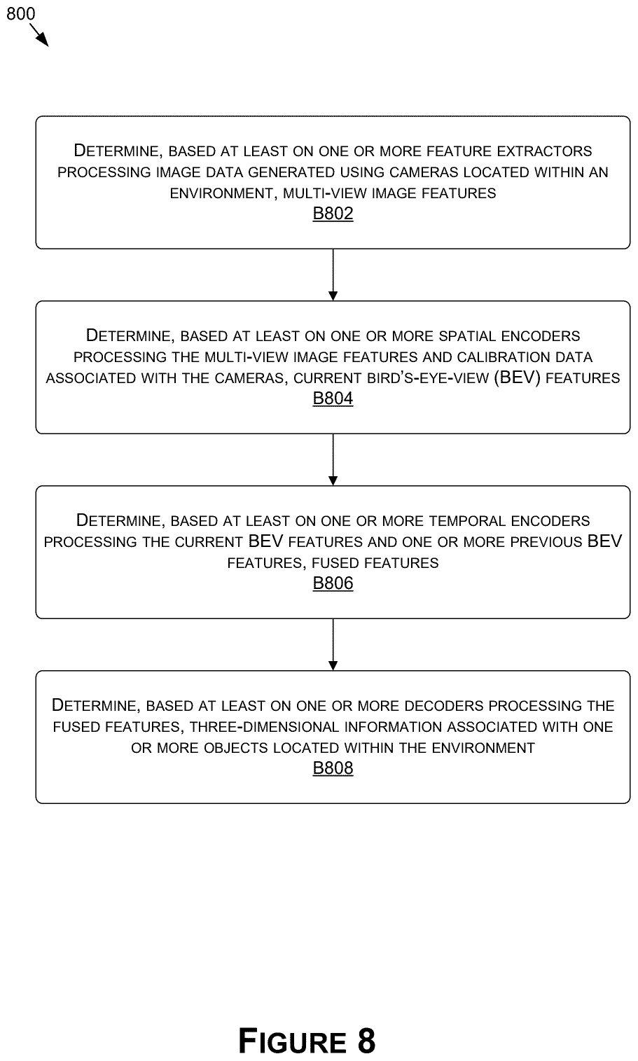

FIG. 8 illustrates a flow diagram showing another method 800 for performing three-dimensional multi-camera perception associated with an environment, in accordance with some embodiments of the present disclosure. The method 800, at block B802, may include determining, based at least on one or more feature extractors processing image data generated using cameras located within an environment, multi-view image features. For instance, the backbone(s) 120 (e.g., the feature extractor(s) 106) may process the image data 104 representing the images 122, where the image data 104 is generated using the cameras 102 located within the environment. Based at least on the processing, the backbone(s) 120 may generate feature data 108 representing the multi-view image features 124 associated with the images 122. For instance, in some examples, the backbone(s) 120 may generate respective feature data 108 that represents one or more image features for each image 122.

The method 800, at block B804, may include determining, based at least on one or more spatial encoders processing the multi-view image features and calibration data associated with the cameras, current bird's-eye-view (BEV) features. For instance, the spatial encoder(s) 126 (and/or the spatio-temporal transformer(s) 110) may process the feature data 108 representing the multi-view image features 124 and the calibration data 112 in order to determine the current BEV features 130(1) associated with the images 122. As described herein, in some examples, the spatial encoder(s) 126 may process additional data, such as the query data 128, to determine the current BEV features 130(1).

The method 800, at block B806, may include determining, based at least on one or more temporal encoders processing the current BEV features and one or more previous BEV features, fused features. For instance, the temporal encoder(s) 132 (and/or the spatio-temporal transformer(s) 110) may process the current BEV features 130(1) along with one or more previous BEV feature(s) 130(O) associated with one or more previous instances in time. Based at least on the processing, the temporal encoder(s) 132 may generate the fused features. As described herein, in some examples, the temporal encoder(s) 132 may perform any technique to determine the fused features, such as by associating the BEV features 130(1)-(O) with one another.

The method 800, at block B808, may include determining, based at least on one or more decoders processing the fused features, three-dimensional information associated with one or more objects located within the environment. For instance, the decoder(s) 134 (and/or the spatio-temporal transformer(s) 110) may determine the 3D information associated with the object(s) based at least on the fused features. As described herein, the 3D information may include at least one or more 3D locations, such as one or more 3D bounding shapes, associated with the object(s).

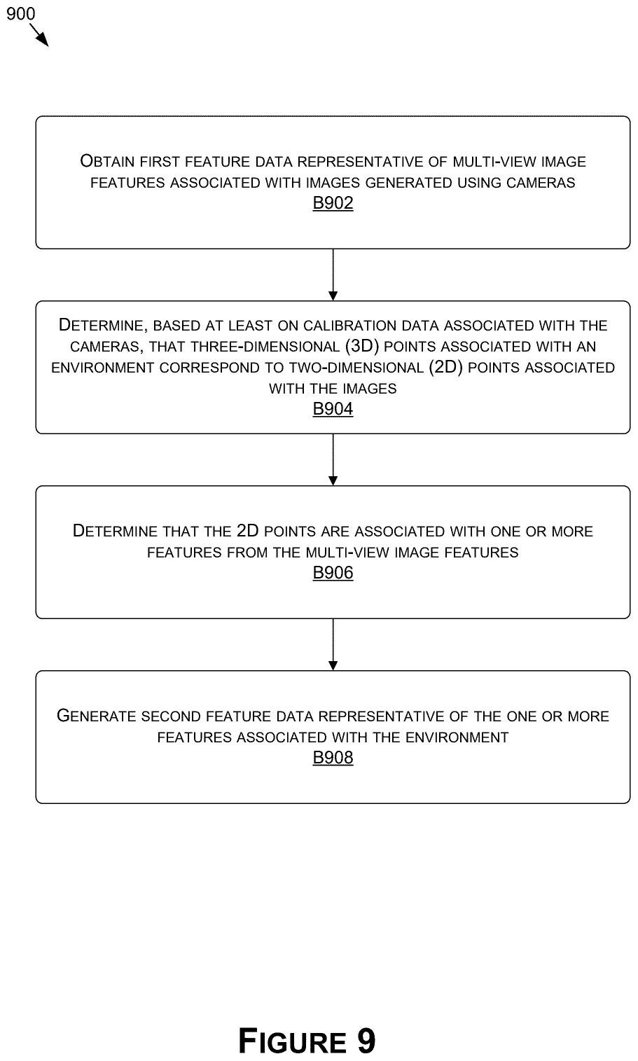

FIG. 9 illustrates a flow diagram showing a method 900 for determining birds-eye-view features based at least on multi-view image features, in accordance with some embodiments of the present disclosure. The method 900, at block B902, may include obtaining first feature data representative of multi-view image features associated with images generated using cameras. For instance, the feature extractor(s) 106 (e.g., the backbone(s) 120) may process the image data 104 representing the images 122, where the image data 104 is generated using the cameras 102 located within the environment. Based at least on the processing, the feature extractor(s) 106 may generate the feature data 108 representing the multi-view image features 124 associated with the images 122. For instance, in some examples, the feature extractor(s) 106 may generate respective feature data 108 that represents one or more image features for each image 122.

The method 900, at block B904, may include determining, based at least on the calibration data associated with the cameras, that three-dimensional (3D) points associated with an environment correspond to two-dimensional (2D) points associated with the images. For instance, the calibration data 112 for the cameras 102 may relate 3D coordinates within the environment to 2D coordinates associated with the images 122. As such, the calibration data 112 may be used to project the 3D points within the environment to the 2D points associated with the images 122. In some examples, since the cameras 102 may be stationary within the environment, the calibration data 112 may associate the same 3D points within the environment with the same 2D points within the images generated using the cameras 102 over a period of time.

The method 900, at block B906, may include determining that the 2D points are associated with one or more features of the multi-view image features. For instance, the spatio-temporal transformer(s) 110 (e.g., the spatial encoder(s) 126) may determine, based at least on the projections, that the feature(s) is associated with the 2D points within the images 122.

The method 900, at block B908, may include generating second feature data representative of the one or more features associated with the environment 908. For instance, the spatio-temporal transformer(s) 110 (e.g., the spatial encoder(s) 126) may generate the second feature data representative of the feature(s), where the feature(s) corresponds to the BEV features 130(1)-(O). As described herein, the second feature data may then be used to determine 3D information associated with one or more objects located within the environment.

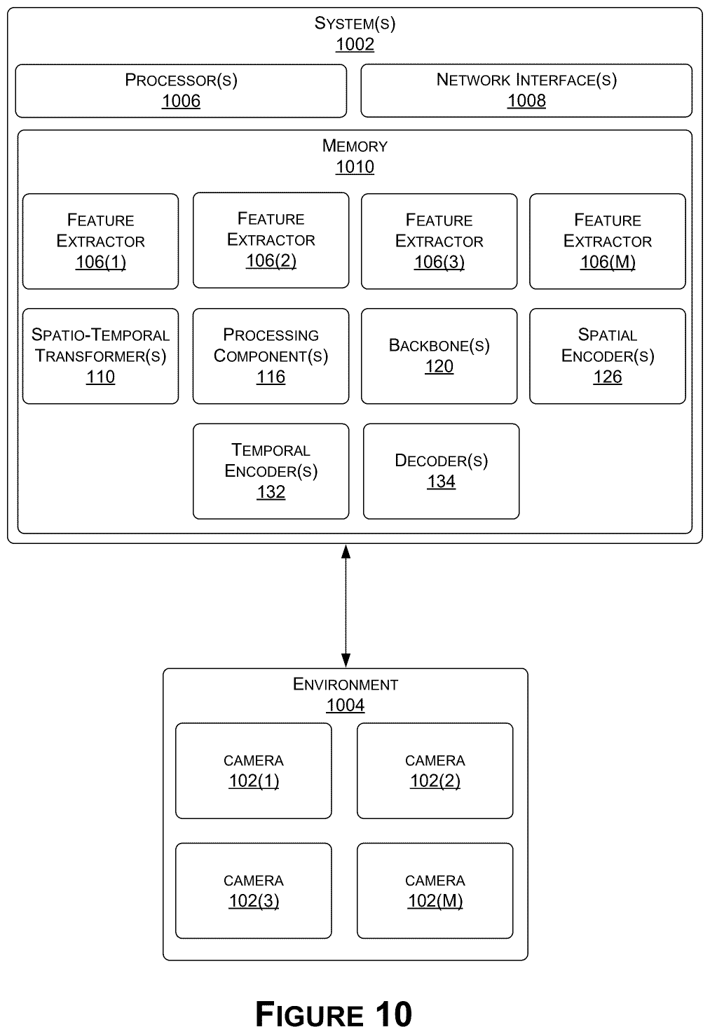

FIG. 10 illustrates an example architecture where one or more of the processes described herein may be performed, in accordance with some embodiments of the present disclosure. As shown, the architecture may include at least one or more systems 1002 (which may be similar to, and/or represent, an example computing device(s) 1100 and/or an example data center(s) 1200) and an environment 1004 (which may represent, and/or include, the environment 202) that includes the cameras 102 located at various locations. Additionally, the system(s) 1002 may include at least one or more processors 1006 (which may be similar to, and/or include, a CPU(s) 1106 and/or a GPU 1108), one or more network interfaces 1008 (which may be similar to, and/or include, a communication interface(s) 1110), and memory 1010 (which may be similar to, and/or include, a memory 1104). In some examples, the system(s) 1002 may be remote from the environment 1004, such as by including one or more edge devices, and communicate with the cameras 102.

As further shown, the memory 1010 may include at least the feature extractors 106, the spatio-temporal transformer(s) 110, the processing component(s) 116, the backbone(s) 120, the spatial encoder(s) 126, the temporal encoder(s) 132, and/or the decoder(s) 134. As such, the system(s) 1002 may be configured to execute at least a portion of the processes described herein, such as the process 100 and/or the process 118, to perform three-dimensional multi-camera perception. While the example of FIG. 10 illustrates the feature extractors 106, the spatio-temporal transformer(s) 110, the processing component(s) 116, the backbone(s) 120, the spatial encoder(s) 126, the temporal encoder(s) 132, and/or the decoder(s) 134 as being stored in the memory 1010, in other examples, one or more of the feature extractors 106, the spatio-temporal transformer(s) 110, the processing component(s) 116, the backbone(s) 120, the spatial encoder(s) 126, the temporal encoder(s) 132, and/or the decoder(s) 134 may include hardware components outside of the memory 1010.

### Example Computing Device

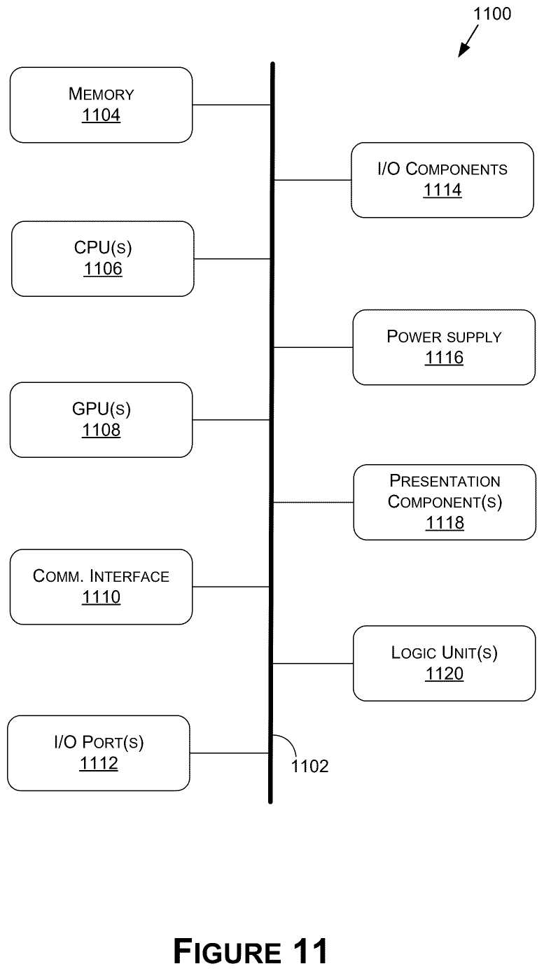

FIG. 11 is a block diagram of an example computing device(s) 1100 suitable for use in implementing some embodiments of the present disclosure. Computing device 1100 may include an interconnect system 1102 that directly or indirectly couples the following devices: memory 1104, one or more central processing units (CPUs) 1106, one or more graphics processing units (GPUs) 1108, a communication interface 1110, input/output (I/O) ports 1112, input/output components 1114, a power supply 1116, one or more presentation components 1118 (e.g., display(s)), and one or more logic units 1120. In at least one embodiment, the computing device(s) 1100 may comprise one or more virtual machines (VMs), and/or any of the components thereof may comprise virtual components (e.g., virtual hardware components). For non-limiting examples, one or more of the GPUs 1108 may comprise one or more vGPUs, one or more of the CPUs 1106 may comprise one or more vCPUs, and/or one or more of the logic units 1120 may comprise one or more virtual logic units. As such, a computing device(s) 1100 may include discrete components (e.g., a full GPU dedicated to the computing device 1100), virtual components (e.g., a portion of a GPU dedicated to the computing device 1100), or a combination thereof.

Although the various blocks of FIG. 11 are shown as connected via the interconnect system 1102 with lines, this is not intended to be limiting and is for clarity only. For example, in some embodiments, a presentation component 1118, such as a display device, may be considered an I/O component 1114 (e.g., if the display is a touch screen). As another example, the CPUs 1106 and/or GPUs 1108 may include memory (e.g., the memory 1104 may be representative of a storage device in addition to the memory of the GPUs 1108, the CPUs 1106, and/or other components). In other words, the computing device of FIG. 11 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 11.

The interconnect system 1102 may represent one or more links or busses, such as an address bus, a data bus, a control bus, or a combination thereof. The interconnect system 1102 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1106 may be directly connected to the memory 1104. Further, the CPU 1106 may be directly connected to the GPU 1108. Where there is direct, or point-to-point connection between components, the interconnect system 1102 may include a PCIe link to carry out the connection. In these examples, a PCI bus need not be included in the computing device 1100.

The memory 1104 may include any of a variety of computer-readable media. The computer-readable media may be any available media that may be accessed by the computing device 1100. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1104 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1100. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1106 may be configured to execute at least some of the computer-readable instructions to control one or more components of the computing device 1100 to perform one or more of the methods and/or processes described herein. The CPU(s) 1106 may each include one or more cores (e.g., one, two, four, eight, twenty-eight, seventy-two, etc.) that are capable of handling a multitude of software threads simultaneously. The CPU(s) 1106 may include any type of processor, and may include different types of processors depending on the type of computing device 1100 implemented (e.g., processors with fewer cores for mobile devices and processors with more cores for servers). For example, depending on the type of computing device 1100, the processor may be an Advanced RISC Machines (ARM) processor implemented using Reduced Instruction Set Computing (RISC) or an x86 processor implemented using Complex Instruction Set Computing (CISC). The computing device 1100 may include one or more CPUs 1106 in addition to one or more microprocessors or supplementary co-processors, such as math co-processors.

In addition to or alternatively from the CPU(s) 1106, the GPU(s) 1108 may be configured to execute at least some of the computer-readable instructions to control one or more components of the computing device 1100 to perform one or more of the methods and/or processes described herein. One or more of the GPU(s) 1108 may be an integrated GPU (e.g., with one or more of the CPU(s) 1106 and/or one or more of the GPU(s) 1108 may be a discrete GPU. In embodiments, one or more of the GPU(s) 1108 may be a coprocessor of one or more of the CPU(s) 1106. The GPU(s) 1108 may be used by the computing device 1100 to render graphics (e.g., 3D graphics) or perform general purpose computations. For example, the GPU(s) 1108 may be used for General-Purpose computing on GPUs (GPGPU). The GPU(s) 1108 may include hundreds or thousands of cores that are capable of handling hundreds or thousands of software threads simultaneously. The GPU(s) 1108 may generate pixel data for output images in response to rendering commands (e.g., rendering commands from the CPU(s) 1106 received via a host interface). The GPU(s) 1108 may include graphics memory, such as display memory, for storing pixel data or any other suitable data, such as GPGPU data. The display memory may be included as part of the memory 1104. The GPU(s) 1108 may include two or more GPUs operating in parallel (e.g., via a link). The link may directly connect the GPUs (e.g., using NVLINK) or may connect the GPUs through a switch (e.g., using NVSwitch). When combined together, each GPU 1108 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1106 and/or the GPU(s) 1108, the logic unit(s) 1120 may be configured to execute at least some of the computer-readable instructions to control one or more components of the computing device 1100 to perform one or more of the methods and/or processes described herein. In embodiments, the CPU(s) 1106, the GPU(s) 1108, and/or the logic unit(s) 1120 may discretely or jointly perform any combination of the methods, processes and/or portions thereof. One or more of the logic units 1120 may be part of and/or integrated in one or more of the CPU(s) 1106 and/or the GPU(s) 1108 and/or one or more of the logic units 1120 may be discrete components or otherwise external to the CPU(s) 1106 and/or the GPU(s) 1108. In embodiments, one or more of the logic units 1120 may be a coprocessor of one or more of the CPU(s) 1106 and/or one or more of the GPU(s) 1108.

Examples of the logic unit(s) 1120 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1110 may include one or more receivers, transmitters, and/or transceivers that enable the computing device 1100 to communicate with other computing devices via an electronic communication network, included wired and/or wireless communications. The communication interface 1110 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1120 and/or communication interface 1110 may include one or more data processing units (DPUs) to transmit data received over a network and/or through interconnect system 1102 directly to (e.g., a memory of) one or more GPU(s) 1108.

The I/O ports 1112 may enable the computing device 1100 to be logically coupled to other devices including the I/O components 1114, the presentation component(s) 1118, and/or other components, some of which may be built in to (e.g., integrated in) the computing device 1100. Illustrative I/O components 1114 include a microphone, mouse, keyboard, joystick, game pad, game controller, satellite dish, scanner, printer, wireless device, etc. The I/O components 1114 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1100. The computing device 1100 may be include depth cameras, such as stereoscopic camera systems, infrared camera systems, RGB camera systems, touchscreen technology, and combinations of these, for gesture detection and recognition. Additionally, the computing device 1100 may include accelerometers or gyroscopes (e.g., as part of an inertia measurement unit (IMU)) that enable detection of motion. In some examples, the output of the accelerometers or gyroscopes may be used by the computing device 1100 to render immersive augmented reality or virtual reality.

The power supply 1116 may include a hard-wired power supply, a battery power supply, or a combination thereof. The power supply 1116 may provide power to the computing device 1100 to enable the components of the computing device 1100 to operate.

The presentation component(s) 1118 may include a display (e.g., a monitor, a touch screen, a television screen, a heads-up-display (HUD), other display types, or a combination thereof), speakers, and/or other presentation components. The presentation component(s) 1118 may receive data from other components (e.g., the GPU(s) 1108, the CPU(s) 1106, DPUs, etc.), and output the data (e.g., as an image, video, sound, etc.).

### Example Data Center

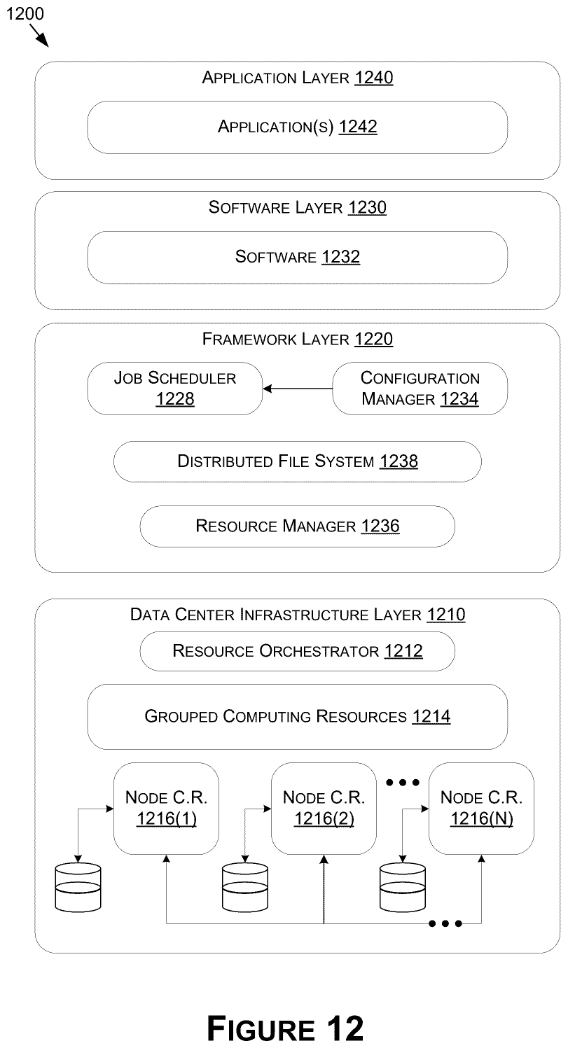

FIG. 12 illustrates an example data center 1200 that may be used in at least one embodiments of the present disclosure. The data center 1200 may include a data center infrastructure layer 1210, a framework layer 1220, a software layer 1230, and/or an application layer 1240.

As shown in FIG. 12, the data center infrastructure layer 1210 may include a resource orchestrator 1212, grouped computing resources 1214, and node computing resources (“node C.R.s”) 1216(1)-1216(N), where “N” represents any whole, positive integer. In at least one embodiment, node C.R.s 1216(1)-1216(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1216(1)-1216(N) may correspond to a server having one or more of the above-mentioned computing resources. In addition, in some embodiments, the node C.R.s 1216(1)-12161(N) may include one or more virtual components, such as vGPUs, vCPUs, and/or the like, and/or one or more of the node C.R.s 1216(1)-1216(N) may correspond to a virtual machine (VM).

In at least one embodiment, grouped computing resources 1214 may include separate groupings of node C.R.s 1216 housed within one or more racks (not shown), or many racks housed in data centers at various geographical locations (also not shown). Separate groupings of node C.R.s 1216 within grouped computing resources 1214 may include grouped compute, network, memory or storage resources that may be configured or allocated to support one or more workloads. In at least one embodiment, several node C.R.s 1216 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1212 may configure or otherwise control one or more node C.R.s 1216(1)-1216(N) and/or grouped computing resources 1214. In at least one embodiment, resource orchestrator 1212 may include a software design infrastructure (SDI) management entity for the data center 1200. The resource orchestrator 1212 may include hardware, software, or some combination thereof.

In at least one embodiment, as shown in FIG. 12, framework layer 1220 may include a job scheduler 1228, a configuration manager 1234, a resource manager 1236, and/or a distributed file system 1238. The framework layer 1220 may include a framework to support software 1232 of software layer 1230 and/or one or more application(s) 1242 of application layer 1240. The software 1232 or application(s) 1242 may respectively include web-based service software or applications, such as those provided by Amazon Web Services, Google Cloud and Microsoft Azure. The framework layer 1220 may be, but is not limited to, a type of free and open-source software web application framework such as Apache Spark™ (hereinafter “Spark”) that may utilize distributed file system 1238 for large-scale data processing (e.g., “big data”). In at least one embodiment, job scheduler 1228 may include a Spark driver to facilitate scheduling of workloads supported by various layers of data center 1200. The configuration manager 1234 may be capable of configuring different layers such as software layer 1230 and framework layer 1220 including Spark and distributed file system 1238 for supporting large-scale data processing. The resource manager 1236 may be capable of managing clustered or grouped computing resources mapped to or allocated for support of distributed file system 1238 and job scheduler 1228. In at least one embodiment, clustered or grouped computing resources may include grouped computing resource 1214 at data center infrastructure layer 1210. The resource manager 1236 may coordinate with resource orchestrator 1212 to manage these mapped or allocated computing resources.

In at least one embodiment, software 1232 included in software layer 1230 may include software used by at least portions of node C.R.s 1216(1)-1216(N), grouped computing resources 1214, and/or distributed file system 1238 of framework layer 1220. One or more types of software may include, but are not limited to, Internet web page search software, e-mail virus scan software, database software, and streaming video content software.

In at least one embodiment, application(s) 1242 included in application layer 1240 may include one or more types of applications used by at least portions of node C.R.s 1216(1)-1216(N), grouped computing resources 1214, and/or distributed file system 1238 of framework layer 1220. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1234, resource manager 1236, and resource orchestrator 1212 may implement any number and type of self-modifying actions based on any amount and type of data acquired in any technically feasible fashion. Self-modifying actions may relieve a data center operator of data center 1200 from making possibly bad configuration decisions and possibly avoiding underutilized and/or poor performing portions of a data center.

The data center 1200 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1200. In at least one embodiment, trained or deployed machine learning models corresponding to one or more neural networks may be used to infer or predict information using resources described above with respect to the data center 1200 by using weight parameters calculated through one or more training techniques, such as but not limited to those described herein.

In at least one embodiment, the data center 1200 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1100 of FIG. 11—e.g., each device may include similar components, features, and/or functionality of the computing device(s) 1100. In addition, where backend devices (e.g., servers, NAS, etc.) are implemented, the backend devices may be included as part of a data center 1200, an example of which is described in more detail herein with respect to FIG. 12.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1100 described herein with respect to FIG. 11. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### Example Paragraphs

A: A method comprising: determining, based at least on processing image data generated using a plurality of cameras located within an environment, one or more first features associated with a plurality of images represented by the image data; determining, based at least on one or more spatial encoders processing the one or more first features and calibration data that relates one or more three-dimensional (3D) coordinates associated with the environment to one or more two-dimensional (2D) coordinates associated with the plurality of images, one or more second features associated with the environment; determining, based at least on one or more decoders processing the one or more second features, one or more 3D locations associated with one or more objects located within the environment; and performing one or more operations based at least on the one or more 3D locations.

B: The method of paragraph A, further comprising: generating, based at least on one or more temporal encoders processing the one or more second features and one or more previous features associated with the environment, one or more fused features, wherein the determining the one or more 3D locations is based at least on the one or more decoders processing the one or more fused features.

C: The method of paragraph B, wherein: the one or more second features are associated with the image data generated using the plurality of cameras during a first time period; and the one or more previous features are associated with second image data generated using the plurality of cameras during a second time period that precedes the first time period.

D: The method of any one of paragraphs A-C, wherein: a first portion of the one or more first features is associated with a first image of the plurality of images and a second portion of the one or more first features is associated with a second image of the plurality of images; and the determining the one or more second features is by at least aggregating the first portion of the one or more first features with the second portion of the one or more first features.

E: The method of any one of paragraphs A-D, wherein the calibration data represents at least matrices for projecting the 3D coordinates within the environment to the 2D coordinates associated with the plurality of images.

F: The method of any one of paragraphs A-E, wherein the determining the one or more second features comprises: determining, based at least on the one or more spatial encoders processing the calibration data, that 3D points within the environment are associated with 2D points within the plurality of images; determining, based at least on the one or more first features, that the 2D points are associated with the one or more second features; and associating, based at least on the 2D points being associated with the one or more second features, the one or more second features with the 3D points.

G: The method of any one of paragraphs A-F, wherein: the plurality of cameras is located within the environment and oriented such that the plurality of cameras includes fields-of-view representing at least a portion of an interior of the environment; and the one or more objects include one or more dynamic objects located within the interior of the environment.

H: The method of any one of paragraphs A-G, wherein the one or more operations include at least one of: determining one or more tracks associated with the one or more objects within environment; determining one or more classifications associated with the one or more objects; determining one or more 2D locations associated with the one or more objects within the plurality of images; or causing a presentation of information associated with the one or more 3D locations.

I: A system comprising: one or more processors to: determine, based at least on image data generated using a plurality of cameras located within an environment, one or more first features associated with a plurality of images represented by the image data; determine, based at least on the one or more first features and calibration data that relates three-dimensional (3D) points within the environment to two-dimensional (2D) points associated with the plurality of images, one or more second features that are associated with the environment; determine, based at least on the one or more second features, one or more 3D locations associated with one or more objects located within the environment; and perform one or more operations based at least on the one or more 3D locations.

J: The system of paragraph I, wherein the one or more processors are further to: determine, based at least on second image data generated using the plurality of cameras located within the environment, one or more third features associated with second images represented by the second image data; and determine, based at least on the one or more third features and the calibration data, one or more fourth features that are associated with the environment, wherein the one or more 3D locations are further determined based at least on the one or more fourth features.

K: The system of paragraph J, wherein: the image data is generated using the plurality of cameras during a first time period; and the second image data is generated using the plurality of cameras during a second time period that is different than the first time period.

L: The system of paragraph J, wherein the one or more processors are further to: generate, based at least on one or more temporal encoders processing the one or more second features and the one or more fourth features, one or more fused features; wherein the one or more 3D locations are determined based at least on the one or more fused features.

M: The system of any one of paragraphs I-L, wherein: a first portion of the one or more first features is associated with a first image of the plurality of images and a second portion of the one or more first features is associated with a second image of the plurality of images; and the determination of the one or more second features comprises determining, based at least on one or more spatial encoders processing the one or more first features and the calibration data, the one or more second features by aggregating the first portion of the one or more first features with the second portion of the one or more first features.

N: The system of any one of paragraphs I-M, wherein the determination of the one or more second features comprises: determining, based at least on one or more spatial encoders processing the calibration data, that 3D points within the environment are associated with 2D points within the plurality of images; determining, based at least on the one or more first features, that the 2D points are associated with the one or more second features; and associating, based at least on the 2D points being associated with the one or more second features, the one or more second features with the 3D points.

O: The system of any one of paragraphs I-N, wherein the calibration data represents matrices for projecting the 3D points associated with the environment to the 2D points associated with the plurality of cameras.

P: The system of any one of paragraphs I-O, wherein the determination of the one or more 3D locations associated with the one or more objects is further based at least on data representative of one or more objects queries, the one or more object queries indicating one or more locations at which the one or more objects may be located within the environment.

Q: The system of any one of paragraphs I-P, wherein: the plurality of cameras is located within the environment and oriented such that the plurality of cameras includes fields-of-view representing at least a portion of an interior of the environment; and the one or more objects include one or more dynamic objects located within the interior of the environment.

R: The system of any one of paragraphs I-Q, wherein the system is comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system for performing one or more deep learning operations; a system implemented using an edge device; a system implemented using a robot; a system for performing one or more generative AI operations; a system for performing operations using one or more small language models; a system for performing operations using one or more large language models; a system for performing operations using one or more vision language models (VLMs); a system for performing one or more conversational AI operations; a system for generating synthetic data; a system for presenting at least one of virtual reality content, augmented reality content, or mixed reality content; a system incorporating one or more virtual machines (VMs); a system implemented at least partially in a data center; or a system implemented at least partially using cloud computing resources.

S: One or more processors comprising: processing circuitry to: generate, based at least on first feature data associated with image data generated using a plurality of cameras within an environment and calibration data that relates three-dimensional (3D) points within the environment to two-dimensional (2D) points associated with the plurality of cameras, second feature data that is associated with the environment; determine, based at least on the second feature data, one or more 3D locations associated with one or more objects located within the environment; and perform one or more operations based at least on the one or more 3D locations.

T: The one or more processors of paragraph S, wherein the one or more processors are comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system for performing one or more deep learning operations; a system implemented using an edge device; a system implemented using a robot; a system for performing one or more generative AI operations; a system for performing operations using one or more small language models; a system for performing operations using one or more large language models; a system for performing operations using one or more vision language models (VLMs); a system for performing one or more conversational AI operations; a system for generating synthetic data; a system for presenting at least one of virtual reality content, augmented reality content, or mixed reality content; a system incorporating one or more virtual machines (VMs); a system implemented at least partially in a data center; or a system implemented at least partially using cloud computing resources.

What is claimed is:

1. A method comprising:
determining, based at least on processing image data generated using a plurality of cameras located within an environment, one or more first features associated with a plurality of images represented by the image data;
determining, based at least on one or more spatial encoders processing the one or more first features and calibration data that relates one or more three-dimensional (3D) coordinates associated with the environment to one or more two-dimensional (2D) coordinates associated with the plurality of images, one or more second features associated with the environment;
determining, based at least on one or more decoders processing the one or more second features, one or more 3D locations associated with one or more objects located within the environment; and
performing one or more operations based at least on the one or more 3D locations.

2. The method of claim 1, further comprising:
generating, based at least on one or more temporal encoders processing the one or more second features and one or more previous features associated with the environment, one or more fused features,
wherein the determining the one or more 3D locations is based at least on the one or more decoders processing the one or more fused features.

3. The method of claim 2, wherein:
the one or more second features are associated with the image data generated using the plurality of cameras during a first time period; and
the one or more previous features are associated with second image data generated using the plurality of cameras during a second time period that precedes the first time period.

4. The method of claim 1, wherein:
a first portion of the one or more first features is associated with a first image of the plurality of images and a second portion of the one or more first features is associated with a second image of the plurality of images; and
the determining the one or more second features is by at least aggregating the first portion of the one or more first features with the second portion of the one or more first features.

5. The method of claim 1, wherein the calibration data represents at least matrices for projecting the 3D coordinates within the environment to the 2D coordinates associated with the plurality of images.

6. The method of claim 1, wherein the determining the one or more second features comprises:
determining, based at least on the one or more spatial encoders processing the calibration data, that 3D points within the environment are associated with 2D points within the plurality of images;
determining, based at least on the one or more first features, that the 2D points are associated with the one or more second features; and
associating, based at least on the 2D points being associated with the one or more second features, the one or more second features with the 3D points.

7. The method of claim 1, wherein:
the plurality of cameras is located within the environment and oriented such that the plurality of cameras includes fields-of-view representing at least a portion of an interior of the environment; and
the one or more objects include one or more dynamic objects located within the interior of the environment.

8. The method of claim 1, wherein the one or more operations include at least one of:
determining one or more tracks associated with the one or more objects within environment;
determining one or more classifications associated with the one or more objects;
determining one or more 2D locations associated with the one or more objects within the plurality of images; or
causing a presentation of information associated with the one or more 3D locations.

9. A system comprising:
one or more processors to:
determine, based at least on image data generated using a plurality of cameras located within an environment, one or more first features associated with a plurality of images represented by the image data;
determine, based at least on the one or more first features and calibration data that relates three-dimensional (3D) points within the environment to two-dimensional (2D) points associated with the plurality of images, one or more second features that are associated with the environment;
determine, based at least on the one or more second features, one or more 3D locations associated with one or more objects located within the environment; and
perform one or more operations based at least on the one or more 3D locations.

10. The system of claim 9, wherein the one or more processors are further to:
determine, based at least on second image data generated using the plurality of cameras located within the environment, one or more third features associated with second images represented by the second image data; and
determine, based at least on the one or more third features and the calibration data, one or more fourth features that are associated with the environment,
wherein the one or more 3D locations are further determined based at least on the one or more fourth features.

11. The system of claim 10, wherein:
the image data is generated using the plurality of cameras during a first time period; and
the second image data is generated using the plurality of cameras during a second time period that is different than the first time period.

12. The system of claim 10, wherein the one or more processors are further to:
generate, based at least on one or more temporal encoders processing the one or more second features and the one or more fourth features, one or more fused features;
wherein the one or more 3D locations are determined based at least on the one or more fused features.

13. The system of claim 9, wherein:
a first portion of the one or more first features is associated with a first image of the plurality of images and a second portion of the one or more first features is associated with a second image of the plurality of images; and
the determination of the one or more second features comprises determining, based at least on one or more spatial encoders processing the one or more first features and the calibration data, the one or more second features by aggregating the first portion of the one or more first features with the second portion of the one or more first features.

14. The system of claim 9, wherein the determination of the one or more second features comprises:
determining, based at least on one or more spatial encoders processing the calibration data, that 3D points within the environment are associated with 2D points within the plurality of images;
determining, based at least on the one or more first features, that the 2D points are associated with the one or more second features; and
associating, based at least on the 2D points being associated with the one or more second features, the one or more second features with the 3D points.

15. The system of claim 9, wherein the calibration data represents matrices for projecting the 3D points associated with the environment to the 2D points associated with the plurality of cameras.

16. The system of claim 9, wherein the determination of the one or more 3D locations associated with the one or more objects is further based at least on data representative of one or more objects queries, the one or more object queries indicating one or more locations at which the one or more objects may be located within the environment.

17. The system of claim 9, wherein:
the plurality of cameras is located within the environment and oriented such that the plurality of cameras includes fields-of-view representing at least a portion of an interior of the environment; and
the one or more objects include one or more dynamic objects located within the interior of the environment.

18. The system of claim 9, wherein the system is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device;
a system implemented using a robot;
a system for performing one or more generative AI operations;
a system for performing operations using one or more small language models;
a system for performing operations using one or more large language models;
a system for performing operations using one or more vision language models (VLMs);
a system for performing one or more conversational AI operations;
a system for generating synthetic data;
a system for presenting at least one of virtual reality content, augmented reality content, or mixed reality content;
a system incorporating one or more virtual machines (VMs);
a system implemented at least partially in a data center; or
a system implemented at least partially using cloud computing resources.

19. One or more processors comprising:
processing circuitry to:
generate, based at least on first feature data associated with image data generated using a plurality of cameras within an environment and calibration data that relates three-dimensional (3D) points within the environment to two-dimensional (2D) points associated with the plurality of cameras, second feature data that is associated with the environment;
determine, based at least on the second feature data, one or more 3D locations associated with one or more objects located within the environment; and
perform one or more operations based at least on the one or more 3D locations.

20. The one or more processors of claim 19, wherein the one or more processors are comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device;
a system implemented using a robot;
a system for performing one or more generative AI operations;
a system for performing operations using one or more small language models;
a system for performing operations using one or more large language models;
a system for performing operations using one or more vision language models (VLMs);
a system for performing one or more conversational AI operations;
a system for generating synthetic data;
a system for presenting at least one of virtual reality content, augmented reality content, or mixed reality content;
a system incorporating one or more virtual machines (VMs);
a system implemented at least partially in a data center; or
a system implemented at least partially using cloud computing resources.
